(19) United States
(12) Patent Application Publication
(10) Pub. No.: US 2010/0026934 A1
(43) Pub. Date: Feb. 4, 2010

(54) Light uniforming polarization recycling film

(75) Inventors: Yu-Ming Sun, Tainan City (TW); Chin-Yi Liao, Tainan City (TW)

Correspondence Address: BACON & THOMAS, PLLC, 625 SLATERS LANE, FOURTH FLOOR, ALEXANDRIA, VA, 22314-1176, US

(73) Assignee: Eternal Chemical Co., Ltd., Kaohsiung City (TW)

(21) Appl. No.: 12/458,180

(22) Filed: Jul. 2, 2009

(30) Foreign Application Priority Data
Jul. 29, 2008 (TW) 097128655

(51) Int. Cl. G02F 1/1347; G02F 1/13

(52) U.S. Cl. 349/74; 349/194

(57) ABSTRACT

Disclosed herein is a light uniforming polarization recycling film comprising a cholesteric liquid crystal layer having a first optical surface and a second optical surface; an optical support formed on the first optical -surface; and alight scattering layer formed on the second optical surface. The light scattering layer includes a ¼ wavelength (quarter wave) plate and a microstructure layer having light diffusing characteristics.

The light uniforming polarization recycling film according to the present invention can facilitate the elimination of chromaticity difference with respect to different visual angles and enhance the brightness of the polarizing film of recycling light.

### BACKGROUND OF THE INVENTION

This invention relates to a light uniforming polarization recycling film, and more particularly, to a polarization recycling film for a backlight module. This invention offers an optical film giving higher brightness, uniform light distribution, and uniformity in color gamut with respect to different viewing angles.

### DESCRIPTION OF RELATED ART

In general, a liquid crystal display (LCD) primarily comprises a display panel and a backlight module. The display panel primarily comprises transparent electrode, liquid crystal, polyimide, color filters, polarizer, driving integrated circuit, etc. The backlight module primarily includes lamp tubes, a light guide plate, and various optical films, etc.

Backlight modules include a direct type and a side edge type according to where the light source device is situated. Generally, side edge type backlights which are thinner in thickness are suitable for notebook computers, while direct type backlights which are thicker in thickness are suitable for display panels of LCD monitors and LCD TVs.

In order to have more uniform light distribution and have control over viewing angles, optical films such as diffusion plates, diffusion films, prism sheets, and reflection plates, which provide different functions, may be assembled into a backlight module. However, this may lead to the material absorption and reflection phenomenon which results in decreased use efficiency of a light source, and thus decreased brightness. In order to enhance higher brightness for a LCD display, the number of lamps used in a backlight module may be increased. However, this has a tendency of accumulating an excess of heat generated by the lamps in the LCD display, resulting in a short lifetime and a poor performance of constituting elements of the LCD display. Furthermore, a large amount of power consumption resulted from the increase in the number of lamps is not favorable for battery-powered portable applications.

To increase brightness, decrease accumulated heat, and lower energy consumption of a light source, one of the most commonly used approaches is to incorporate various optical films into backlight modules. By doing this, the whole brightness is enhanced. One of the commonly known optical films is 3M's DBEF (Dual Brightness Enhancement Film), which is an optical thin film with a thickness of only 132 μm made by laminating about one thousand of birefringent polymer films by using multi-layer optical film technology. Such an optical thin film (DBEF) not only has light polarization effects of conventional polarizers but also can effectively reflect a non-penetrating polarized light back to a backlight module. As the reflection plate of the backlight module has the effects of diffusion and scrambling, the original non-penetrating polarized light is converted into a penetrating polarized light to pass the polarizer. After the repetition of the aforementioned process, most of the light originally to be absorbed and wasted is converted into useful light. By combining a DBEF film with DBEF film, the brightness of the backlight module can be boosted by up to 160%. However, such a reflection polarizer requires multi-layer technology which involves advanced manufacturing processes. Its unit price remains high in the market.

Another approach to enhance brightness is to utilize cholesteric liquid crystal phase reflective polarizer resulted from cholesteric crystal (CLC). Please refer to FIG. 1. The incident light can be separated into right-handed (R-H) circularly polarized light and left-handed (L-H) circularly polarized light. Only the R-H circularly polarized light can pass through (I), while the L-H circularly polarized light is reflected toward the light source. Accordingly, a ¼ wavelength (quarter wave) plate 13 is needed to covert the transmitted circularly polarized light to a linearly polarized light which can be applied in a liquid crystal display system 12. On the other hand, the L-H circularly polarized light which is reflected toward the light source gets reflected by a reflection plate 10 and converted to an R-H polarized light and gets transmitted to the CLC optical film 14. In this manner, the polarization of the light emitted is entirely converted to the polarization that can pass through (II). This approach requires an easier manufacturing process and effectively reduces cost. However, as shown in FIG. 2, such a reflective polarizer leads to a problem to display applications. To be specific, chromaticity difference occurs when a light passing through a reflective polarizer 201 is viewed with different viewing angles. FIG. 2 shows that color distortion occurs in chromaticity coordinates with respect to horizontal viewing angles 0°, 40° and 60°, respectively.

### SUMMARY OF THE INVENTION

Accordingly, the present invention is directed to provide a light uniforming polarization recycling film which can overcome the aforementioned drawbacks. By forming a microstructure layer or a light scattering layer which includes a plurality of diffusion particles having different refractive indexes on CLC layer to lengthen the light path, the uniformity of outgoing lights having different wavelengths can be enhanced. In this manner, the problem in which the undesirable chromaticity difference is observed at different viewing angles can be solved.

The present invention is directed to provide a light uniforming polarization recycling film which can improve the efficiency of the light source.

The present invention is to provide a light uniforming polarization recycling film which functions as a multi-function optical film. With its optical properties such as the effect of diffusion, such a multi-function optical film can reduce the number of the optical films used in the LCD panel and thus the thickness of the LCD panel.

To achieve these and other objects and advantages, the light uniforming polarization recycling film in accordance with the present invention comprises a cholesteric liquid crystal (CLC) layer having a first optical surface and a second optical surface, an optical carrier formed on the first optical surface, and a light scattering layer formed on the second optical surface. The light scattering layer includes a quarter wave (¼λ) plate and a microstructure layer having light diffusing characteristics. The light uniforming polarization recycling film satisfies the following conditions (I) and (II):

Δx≦0.02 (I)

Δy≦0, 02 (II)

Δx=x(at 0°)−x(at 0°)

Δy=y(at 0°)−x(at 0°)

0°≦θ°≦60°

where x(at θ°) is the chromaticity value on the x axis at the horizontal viewing angle θ°, x(at 0°) is the chromaticity value on the x axis at the front viewing angle 0°, Δx is the difference of x(at θ°) and x(at 0°), y(at θ°) is the chromaticity value on the y axis at the horizontal viewing angle θ°, y(at 0°) is the chromaticity value on the y axis at the front viewing angle 0°, and Δy is the difference of y(at θ°) and y(at 0°).

To present more accurate colors at different horizontal viewing angle θ°, Δx is preferably less than or equal to 0.008, and Δy is preferably less than or equal to 0.01 when 0°≦θ°≦60°.

Other objectives, advantages and novel features of the invention will become more apparent from the following detailed description and the accompanying drawings.

### BRIEF DESCRIPTION OF THE DRAWINGS

FIG. 1 shows a schematic view of prior art reflective polarizer;

FIG. 2 is a diagram showing the chromaticity coordinates which correspond to different viewing angles of prior art reflective polarizer;

FIG. 3 is a schematic view of a first embodiment of the polarization recycling film in accordance with the present invention;

FIG. 4 is a schematic view of a second embodiment of the polarization recycling film in accordance with the present invention;

FIG. 5 is a schematic view of a third embodiment the polarization recycling film in accordance with the present invention;

FIG. 6 is a schematic view of a fourth embodiment the polarization recycling film in accordance with the present invention;

FIG. 7 is a schematic view of a fifth embodiment the polarization recycling film in accordance with the present invention; and

FIG. 8 is a schematic view showing that the polarization recycling film can be peeled off from the optical carrier.

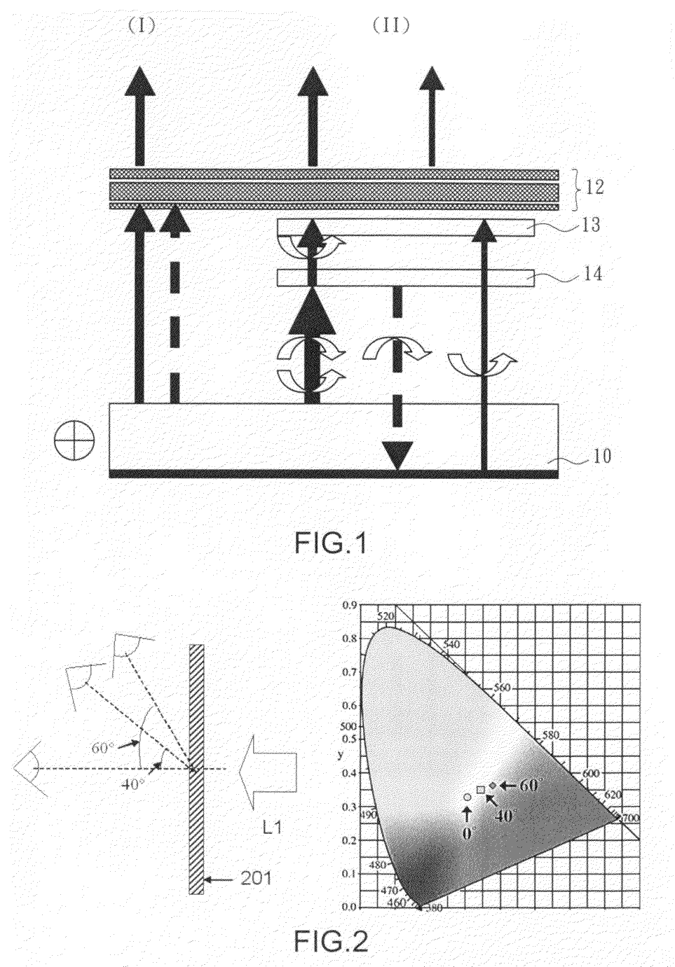

### DETAILED DESCRIPTION OF THE INVENTION

In this description, it should be well acknowledged that “polarization recycling film” is achieved by laminating a semi-reflective and semi-transmissive polarizing film of cholesteric liquid crystal phase (referred to as CLC reflective polarizing film hereinafter) and a ¼ wavelength plate (quarter wave) film. The CLC reflective polarizing film separates the incident light into the right-handed (R-H) circularly polarized light and left-handed (L-H) circularly polarized light. Only the R-H circularly polarized light can pass through the CLC reflective polarizing film, while the L-H circularly polarized light is reflected toward the light source. Accordingly, a ¼ wavelength plate is needed to covert the transmitted circularly polarized light to a linearly polarized light which can be applied in a liquid crystal display system. However, if there is no polarization recycling film in front of the polarizing plate, about 50% of the polarized light will be absorbed. With a polarization recycling film, the polarized light having an opposite polarization is converted to achieve recycling effect.

In this description, it is well acknowledged that “optical support” is used to support an optical thin film and may be glass or plastic, for example. There are no special restrictions with respect to the aforementioned plastic including but not limited to a polyester resin, such as polyethylene terephthalate (PET); a polyacrylate resin, such as poly methyl methacrylate (PMMA); a polyolefin resin, such as polyethylene (PE) or polypropylene (PP); a polyimide resin; a polycarbonate resin; a polyurethane resin; cellulose triacetate (TAC); or a mixture thereof. Preferably, polyethylene terephthalate, poly methyl methacrylate, cellulose triacetate or a mixture thereof is used to form an optical support. There is no restriction on the aforementioned optical support in terms of the amount of the time required to serve as the support of the optical thin film, temporarily or permanently. By applying heat or irradiation to the polarization recycling film of the present invention, the degree of crosslinking of thermo-reactable or photo-sensitive groups in the CLC layer can be increased. Therefore, a polarization recycling layer 310 can be peeled off from an optical support 301, as shown in FIG. 8.

In the polarization recycling film of the present invention, the horizontal viewing angle θ° means the angle between the front viewing angle (which is perpendicular to a screen) and a horizontal plane.

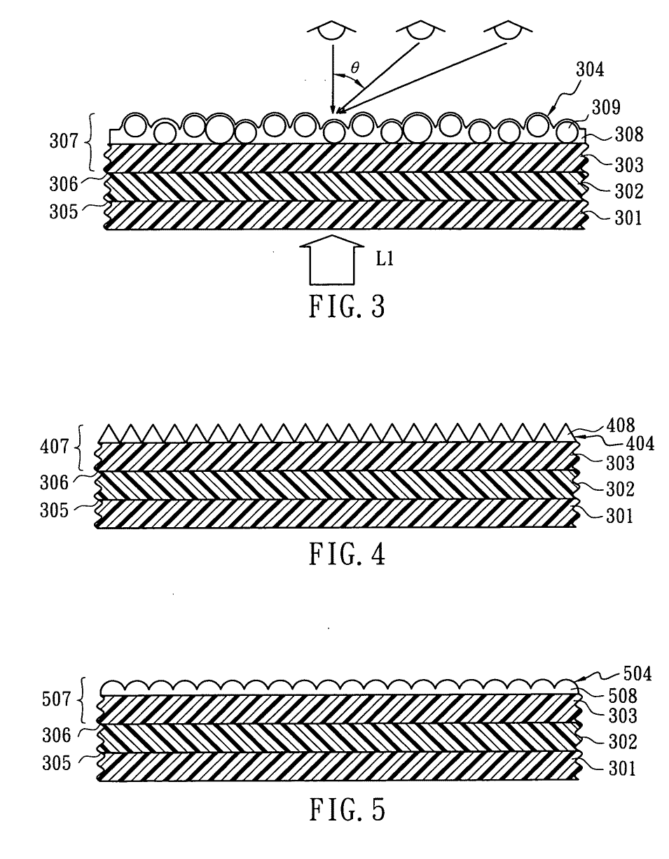

FIG. 3 is a schematic view of the polarization recycling film in accordance with the present invention. The polarization recycling film comprises a CLC layer 302, which includes a first optical surface 305 and a second optical surface 306. An optical support 301 is laminated on the first optical surface 305. A light scattering layer 307 is laminated on the second optical surface 306. The light scattering layer 307 includes a ¼ wavelength plate 303 and a microstructure layer 304 having light diffusing characteristics. The light scattering layer 307 is provided to lengthen the scattering path of outgoing light and to enhance the uniformity of outgoing lights having different wavelengths. In this manner, the undesirable chromaticity difference which is observed at different viewing angles can be suppressed. The microstructure layer 304 of the light scattering layer 307 may be a coating layer containing a plurality of concavo-convex shaped microstructures. According to a preferred embodiment of this invention, the concave-convex shaped microstructure coating layer contains a plurality of diffusion microparticles 309 and a binder 308.

The CLC monomers used in the CLC layer 302 in the polarization recycling film of this invention may be any CLC monomers known to those skilled in the art. Any monomer with a helical structure and which can form Grandjean texture layer, for example, can be used as a respective CLC layer. The CLC monomer may include, but is not limited to, photosensitive ethylenic unsaturated group located on one end or both ends thereof. By applying heat or irradiation to the polarization recycling film of the present invention, the degree of crosslinking of the thermo-reactable or photo-sensitive groups in the CLC layer can be increased. There is no specific restriction on the photosensitive ethylenic unsaturated group, including but not limited to vinyl, allyl, methylallyl, n-butenyl, isobutenyl, vinylphenyl, allylphenyl, propenoxy methyl, propenoxyethyl, propenoxypropyl, propenoxybutyl, propenoxypentyl, propenoxyhexyl, methylpropenoxymethyl, methylpropenoxyethyl, methylpropenoxypropyl, methylpropenoxybytyl, methylpropenoxypentyl, methylpropenoxyhexyl, and the group shown by formula (1)

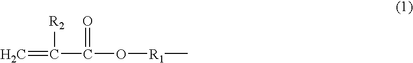

where R₁ is phenylene, C₃-C₈ cycloalkylene, straight or branched C₁-C₈ alkylene, C₁-C₈ alkenylene, or hydroxyl-C₁-C₈; R2 is H or C₁-C₄ alkyl group.
This CLC layer can be a laminate comprising two CLC layers or three or more CLC layers with different helix pitches. Therefore, the CLC layer of the present invention provides a range of different selections in reflection wavelength. The ¼ wavelength plate 303 used in the polarization recycling film in accordance with the present invention can be any ¼ wavelength plate known to those skilled in the art, especially a retardation film which can convert circularly polarized light to linearly polarized light. Such a retardation film may be a polycarbonate retardation film.

FIG. 4 shows the polarization recycling film in accordance with a preferred embodiment of the present invention. Referring to FIG. 4, the polarization recycling film comprises the CLC layer 302, which includes the first optical surface 305 and the second optical surface 306. The optical support 301 is laminated on the first optical surface 305. A light scattering layer 407 is laminated on the second optical surface 306. The light scattering layer 407 includes the ¼ wavelength plate 303 and a microstructure layer 404 having light diffusing characteristics. The microstructure layer 404 may be a coating layer having a plurality of concave-convex shaped microstructures. However, there is no restriction on the shape of the coating layer. Preferably, the microstructure layer 404 may contain a plurality of prism-shaped structures 408 having regular or irregular shapes having an apex angle ranging from 60° to 120°. Such a light scattering layer has a better light condensing effect and thus an improved brightness.

Those skilled in the art should be appreciated that the resin utilized in forming the plurality of prism-shaped structures 408 can by any type suitable for polymerizing polymerization monomers in manufacturing a light condensing layer. Examples of suitable polymerization monomers are epoxy diacrylate, halogenated epoxy diacrylate, methyl methacrylate, isobornyl acrylate, 2-phenoxy ethyl acrylate, acrylamide, styrene, halogenated styrene, acrylic acid, acrylonitrile, methacrylonitrile, biphenylepoxyethyl acrylate, halogenated biphenylepoxyethyl acrylate, alkoxylated epoxy diacrylate, halogenated alkoxylated epoxy diacrylate, aliphatic urethane diacrylate, aliphatic urethane hexaacrylate, aromatic urethane hexaacrylate, bisphenol-A epoxy diacrylate, novolac epoxy acrylate, polyester acrylate, polyester diacrylate, acrylate-capped urethane oligomer, or a mixture thereof. Preferred polymerization monomers are halogenated epoxy diacrylate, methyl methacrylate, 2-phenoxy ethyl acrylate, aliphatic urethane diacrylate, aliphatic urethane hexaacrylate, and aromatic urethane hexaacrylate. The photoinitiator which can be used in the present invention can be any photoinitiator such as benzophenone, as long as it results in the generation of free radicals under light irradiation and then a free-radical polymerization can be initiated. The cross-linking agent which can be used here can be (meth)acrylate, for example, which has one or more functional groups. Those having more functional groups are preferred so as to increase the glass transition temperature.

FIG. 5 shows the polarization recycling film in accordance with another preferred embodiment of the present invention. Referring to FIG. 5, the polarization recycling film comprises a CLC layer 302, which includes the first optical surface 305 and the second optical surface 306. The optical support 301 is laminated on the first optical surface 305. A light scattering layer 507 is laminated on the second optical surface 306. The light scattering layer 507 includes the ¼ wavelength plate 303 and a microstructure layer 504 having light diffusing characteristics. The microstructure layer 504 has a plurality of concave-convex shaped transparent microlens structures 508. Such microstructures have both light diffusing and light condensing effects. There is no specific restriction on the shapes of such microstructures. Preferably, the shapes of the microstructures are hemispheric, with preferred diameters of the hemispheres from 1 to 100 microns and most preferred diameters of the hemispheres from 2 to 50 microns.

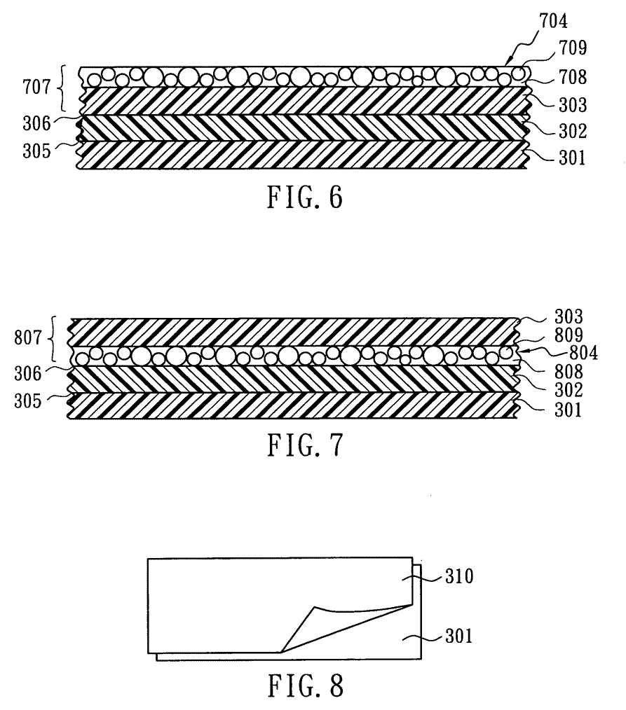

FIG. 6 shows the polarization recycling film in accordance with another preferred embodiment of the present invention. Referring to FIG. 6, the polarization recycling film comprises a CLC layer 302, which includes the first optical surface 305 and the second optical surface 306. The optical support 301 is laminated on the first optical surface 305. A light scattering layer 707 is laminated on the second optical surface 306. The light scattering layer 707 includes the ¼ wavelength plate 303 and a microstructure layer 704 having light diffusing characteristics. The microstructure layer 704 is a coating layer having various refractive indexes because of a plurality of transparent diffuse microparticles 709 and a binder 708 contained therein. There is no specific restriction on the transparent diffusion microparticles 709, as long as the transparent diffusion microparticles 709 have a refractive index which is different from that of the binder 708. In this manner, the microstructure layer 704 offers light diffusing effect when light passes through the microstructure layer 704.

FIG. 7 shows the polarization recycling film in accordance with another preferred embodiment of the present invention. Referring to FIG. 7, the polarization recycling film comprises a CLC layer 302, which includes the first optical surface 305 and the second optical surface 306. The optical carrier 301 is laminated on the first optical surface 305. A light scattering layer 807 is laminated on the second optical surface 306. The light scattering layer 807 includes the ¼ wavelength plate 303 and a microstructure layer 804 having light diffusing characteristics. The microstructure layer 804 contains a plurality of transparent diffusion microparticles 809 and a binder 808. There is no specific restriction on the transparent diffusion microparticles 809, as long as the transparent diffusion microparticles 809 have a refractive index which is different from that of the binder 808. In this manner, the microstructure layer 804 offers light diffusing effect when light passes through the microstructure layer 804.

There is no specific restriction on the diffusion mircroparticles 309, 709 and 809 in terms of the type including but not limited to glass beads, metal oxide mircroparticles or plastic mircroparticles. There is no specific restriction on the plastic microparticles including but not limited to acrylic resin, polystyrene resin, polyurethane resin, silicone resin, or a mixture thereof. There is no specific restriction on the metal oxide microparticles including but not limited to TiO₂, SiO₂, ZnO, BaSO₄, Al₂O₃, ZrO₂, or a mixture thereof. The microparticles 309, 709 and 809 have various diameters between land 100 microns, preferably 2 to 80 microns, and most preferably 5 to 40 microns. The microparticles used in the present invention have a size distribution falling within the range of ±30% of the average particle diameter of the diffusion microparticles, preferably within the range of ±15% of the average particle diameter of the diffusion microparticles. According to the present invention, for example, when the diffusion microparticles have an average particle diameter of 15 microns and a size distribution falling within the range of ±30% of the average particle diameter of the diffusion microparticles, the size distribution of the diffusion microparticles can fall within the range about 10.5 microns to about 19.5 microns. In comparison with the prior art which uses the microparticles with a diameter about 15 microns and a size distribution falling within a range about 1 to 30 microns are used, the present invention that uses the transparent microparticles with a single average particle diameter and a narrow size distribution increases brightness of optical films. The present invention overcomes the problem in which the light from the light source is wasted due to a wide scattering range resulted from overly different diameters of the transparent microparticles.

There is no specific restriction on the binder 308, 708 and 808 in terms of the type including but not limited to acrylic resin, polyamide resin, epoxy resin, fluorine-containing resin, polyimide resin, polyurethane resin, alkyd resin, polyester resin, or a mixture thereof. Acrylic resin, polyurethane resin, polyester resin, or a mixture thereof is preferred. The binder used in the present invention is preferably colorless and transparent for allowing light to pass through.

The light scattering layer of the polarization recycling film according to the present invention can be formed using processes known to those skilled in the art, such as imprinting, casting, injection molding or coating. Preferably, coating process, such as slot die coating, micro gravure coating, and roller coating, is used. Particularly, roll-to-roll technique is employed in manufacturing the microstructure layer containing a plurality of concave-convex microstructures or the coating layer containing diffusion microparticles with various refractive indexes of polarization recycling films.

There is no specific restriction on the location or arrangement of the polarization recycling film according to the present invention. Any location or arrangement known to those skilled in the art can be applied as long as it can improve the efficiency of the liquid crystal display. For example, the polarization recycling film is typically but not exclusively arranged between the polarizing film and the light guide plate of the backlight module, or between the light guide plate and the reflection plate.

### EXAMPLE 1

A plurality of prism-shaped structures having an apex angle of 90° were disposed on the surface of the ¼ wavelength plate in the polarization recycling film.

### EXAMPLE 2

A plurality of hemispheric microlens structures with a diameter of 50 microns were disposed on the surface of the ¼ wavelength plate in the polarization recycling film.

### EXAMPLE 3

A plurality of acrylic resin diffusion microparticles having refractive index of 1.49 were well mixed with a binder having refractive index of 1.52, and a mixture thereof was then applied onto the surface of the ¼ wavelength plate in the polarization recycling film by means of coating and dried to form a concave-convex light scattering layer of 15 microns in thickness.

### EXAMPLE 4

A plurality of acrylic resin diffusion microparticles having refractive index of 1.49 were well mixed with a binder having refractive index of 1.56, and a mixture thereof was then applied onto the surface of the ¼ wavelength plate in the polarization recycling film by means of coating and dried to form a smooth light scattering layer of 15 microns in thickness.

### EXAMPLE 5

A plurality of silicone resin diffusion microparticles having refractive index of 1.42 were well mixed with a binder having refractive index of 1.56, and a mixture thereof was then applied onto the surface of the ¼ wavelength plate in the polarization recycling film by means of coating and dried to form a smooth light scattering layer of 15 microns in thickness.

### COMPARATIVE EXAMPLE 1

A polarization recycling film which is not provided with light diffusion microstructures and of which the polarization recycling layer comprises CLC layer and ¼ wavelength plate

### [Luminance Measurement]

Each of the polarization recycling films of Examples 1, 2, 3, 4 and Comparative example 1 was respectively disposed upon the backlight module of a 7-inch TFT-LCD digital photo frame (Chilin's ST-PF07D1) and then covered with a glass panel. By using a luminance meter (Topcon Company's SC-777), at an angle of 2°, central luminance (cd/m²) was measured at a distance of 50 cm immediately above (i.e., at an angle of 0°) from the backlight source. The brightness gain was accordingly calculated.

### [Chromaticity Variation Measurement]

Each of the polarization recycling films from Examples 1, 2, 3, 4, and Comparative example 1 was respectively disposed upon the backlight module of a 7-inch TFT-LCD digital photo frame (Chilin's ST-PF07D1) and then covered with a glass panel. By using a luminance meter (Topcon Company's SC-777) in front of the backlight source, chromaticity variation in the normal direction (i.e., at an angle of 0°) and an oblique direction (at an angle of 60°) was measured.

TABLE 1

| | Central | |
|---|---|---|
| | Luminance | Brightness |
| 7-inch digital photo frame | (cd/m²) | Gain (%) |
| Backlight source + two | 109.7 | 0 |
| diffusion films + one glass | | |
| panel | | |
| Backlight source + two | 184.8 | +68 |
| diffusion films + one film of | | |
| Example 1 + one glass panel | | |
| Backlight source + two | 164.8 | +50 |
| diffusion films + one film of | | |
| Example 2 + one glass panel | | |
| Backlight source + two | 170.9 | +56 |
| diffusion films + one film of | | |
| Example 3 + one glass panel | | |
| Backlight source + two | 153.2 | +40 |
| diffusion films + one film of | | |
| Example 4 + one glass panel | | |
| Backlight source + two | 156.6 | +43 |
| diffusion films + one film of | | |
| Example 5 + one glass panel | | |
| Backlight source + two | 169.2 | +54 |
| diffusion films + one film of | | |
| Comparative Example 1 + one | | |
| glass panel | | |

It can be seen from Table 1 that the central luminance value of the original 7-inch digital photo frame backlight source is 109.7 cd/M². When two diffusion films, one film of Example 1, and one glass panel are additionally used, the brightness gain of 68% can be achieved, resulting in an enhanced luminance up to 184.8 cd/m². However, 7-inch digital photo frame backlight source, two diffusion films, one film of Example 1, and one glass panel can only provide brightness gain of 54% and a luminance up to 456.1 cd/m². In comparison with the module consisting of 7-inch digital photo frame backlight source plus additional two diffusion films, one film of Comparative Example 1 and one glass panel, the film of Example 1 of the present invention can provide better brightness gain.

TABLE 2

Chromaticity
difference

| | Δx | Δy |
|---|---|---|
| Example 1 | −0.0018 | −0.0095 |
| Example 2 | −0.0025 | −0.0126 |
| Example 3 | −0.0018 | −0.0094 |
| Example 4 | 0.0117 | −0.0172 |
| Example 5 | 0.0062 | −0.017 |
| Example 6 | 0.0427 | 0.0122 |

Chromaticity differences Δx and Δy are the differences of the chromaticity value x in an oblique direction(60° from the normal) and in the normal (at 0°) on the x axis, and chromaticity value y in an oblique direction (60° from the normal) and in the normal (at 0°) on the y axis, respectively. The differences are evaluated using absolute values thereof. As shown in Table 2, the chromaticity differences of Examples, 1, 2, 3, 4 and 5 are considerably small than that of Comparative Example 1. Therefore, it should be appreciated that the light uniforming polarization recycling film of the present invention can significantly mend the problem of the polarization recycling film in which the undesirable chromaticity difference is observed at different viewing angles. The comparison of the chromaticity differences between Example 3 and Example 4 shows that the chromaticity difference of smooth polarization recycling film is large than the chromaticity difference of concave-convex polarization recycling film. The comparison of the chromaticity differences between Example 4 and Example 5 shows that given the same smooth polarization recycling film, the larger the difference between the refraction indexes of the diffusion microparticles and the binder, the more the chromaticity difference is decreased. In view of Table 1 and Table 2, Example 1 of the present invention can not only enhance optical brightness but also solve the prior art problems and disadvantages in which the undesirable chromaticity difference is observed at different viewing angles. Therefore, the present invention can replace conventional designs and be applied to backlight modules of LCDs and LCD TVs.

It should be understood by those skilled in the art that various modifications, combinations, sub-combinations and alternations may occur depending on design requirements and other factors insofar as they are within the scope of the appended claims or the equivalents thereof.

1. A light uniforming polarization recycling film comprising:
a cholesteric liquid crystal layer having a first optical surface and a second optical surface;
an optical support formed on the first optical surface; and
a light scattering layer formed on the second optical surface, wherein
the light scattering layer includes a ¼ wavelength (quarter wave) plate and a microstructure layer having light diffusing characteristics, and
the light uniforming polarization recycling film satisfies the following conditions:
Δx≦0.02 (I)
Δy≦0,02 (II)
Δx=x(at θ°)−x(at 0°)
Δy=y(at θ°)−x(at 0°)
0°≦θ°≦60°
where x(at θ°) is the chromaticity value on the x axis at the horizontal viewing angle θ°, x(at 0°) is the chromaticity value on the x axis at the front viewing angle 0°, Δx is the difference of x(at θ°) and x(at 0°), y(at θ°) is the chromaticity value on the y axis at the horizontal viewing angle θ°, y(at 0°) is the chromaticity value on the y axis at the front viewing angle 0°, and Δy is the difference of y(at θ°) and y(at 0°).

2. The light uniforming polarization recycling film as claimed in claim 1, wherein the microstructure layer includes a plurality of prism-shaped structures.

3. The light uniforming polarization recycling film as claimed in claim 2, wherein the plurality of prism-shaped structures have regular or irregular shapes having an apex angle ranging from 60° or 12°.

4. The light uniforming polarization recycling film as claimed in claim 1, wherein the microstructure layer includes a plurality of concavo-convex shaped microlens structures.

5. The light uniforming polarization recycling film as claimed in claim 4, wherein the microlens structures are hemispheric.

6. The light uniforming polarization recycling film as claimed in claim 1, wherein the microstructure layer is a concavo-convex shaped microstructure coating layer including a plurality of diffusion microparticles and a binder.

7. The light uniforming polarization recycling film as claimed in claim 1, wherein the microstructure layer includes a plurality of diffusion microparticles having a first refractive index and a binder having a second refractive index which is different from the first refractive index.

8. The light uniforming polarization recycling film as claimed in claim 6 or 7, wherein the diffusion microparticles have an average particle diameter between 1 micron and 100 microns, and a size distribution falling within the range of ±30% of the average particle diameter of the diffusion microparticles.

9. The light uniforming polarization recycling film as claimed in claim 6 or 7, wherein the diffusion microparticles can be glass beads, metal oxide mircoparticles or plastic microparticles.

10. The light uniforming polarization recycling film as claimed in claim 9, wherein the plastic microparticles are selected from a group consisting of acrylic resin, polystyrene resin, polyurethane resin, silicone resin, and a mixture thereof.

11. The light uniforming polarization recycling film as claimed in claim 6 or 7, wherein the binder are selected from a group consisting of acrylic resin, polyamide resin, epoxy resin, fluorine resin, polyimide resin, polyurethane resin, alkyd resin, polyester resin, and a mixture thereof.

12. The light uniforming polarization recycling film as claimed in claim 1, wherein the microstructure layer is formed by imprinting or coating.

13. The light uniforming polarization recycling film as claimed in claim 1, wherein the optical support is selected from a group consisting of polyethylene terephthalate, poly methylmethacrylate, polyolefin resin, tri-acetyl-cellulose, polylactic acid, and a mixture thereof.

14. A backlight module for LCD, comprising:
a light uniforming polarization recycling film, comprising:
a cholesteric liquid crystal layer having a first optical surface and a second optical surface;
an optical support formed on the first optical surface; and
a light scattering layer formed on the second optical surface, wherein
the light scattering layer includes a ¼ wavelength (quarter wave) plate and a microstructure layer having light diffusing characteristics, and
the light uniforming polarization recycling film satisfies the following conditions:
Δx≦0.02 (I)
Δy≦0,02 (II)
Δx=x(at θ°)−x(at 0°)
Δy=y(at θ°)−x(at 0°)
0°≦θ°≦60°
where x(at θ°)is the chromaticity value on the x axis at the horizontal viewing angle θ°, x(at 0°) is the chromaticity value on the x axis at the front viewing angle 0°, Δx is the difference of x(at θ°) and x(at 0°), y(at θ°) is the chromaticity value on the y axis at the horizontal viewing angle θ°, y(at 0°) is the chromaticity value on the y axis at the front viewing angle 0°, and Δy is the difference of y(at θ°) and y(at 0°).
